(19) United States
(12) Patent Application Publication
(10) Pub. No.: US 2020/0071548 A1
(43) Pub. Date: Mar. 5, 2020

(54) Novel tint bases and a method of preparing tint bases

(71) Applicant: FP-Pigments Oy, Espoo (FI)

(72) Inventor: Paul Dietz, Espoo (FI)

(21) Appl. No.: 16/466,043

(22) PCT Filed: Dec. 1, 2017
(86) PCT No.: PCT/FI2017/050849

§ 371 Date: Jun. 3, 2019

(30) Foreign Application Priority Data
Dec. 2, 2016 (FI) 20165920

(51) Int. Cl. C09D 7/62; C09C 1/00; C09D 17/00; C08K 3/013; C08K 3/22; C08K 3/26

(52) U.S. Cl. CPC C09D 7/62; C09C 1/0084; C09D 17/008; C08K 3/013; C01P 2006/62; C08K 3/26; C08K 2003/2241; C08K 2003/265; C08K 2201/005; C08K 3/22

(57) ABSTRACT

According to an example aspect of the present invention, there is provided a tint base comprising titanium dioxide, a vehicle, and conventional additives, which tint base is capable of displaying a preselected colour upon the addition of a colorant, wherein at least 4% by weight of the titanium dioxide is present in the form of opaque aggregates of titanium dioxide and precipitated calcium carbonate particles wherein the titanium dioxide particles are at least partially encased by the particles of precipitated calcium carbonate.

### FIELD

The present invention relates to tint bases. The invention also relates to a method of preparing tint bases. Further, the invention relates to the use of aggregates as hiding pigments in a tint base.

### BACKGROUND

A tint base comprises a vehicle such as a water-based or a solvent-based paint for carrying a pigment or pigments. Further pigments or dyes (in the following also “colorants”) are typically added to tint bases in order to provide a paint or coating having a desired colour, shade or hue.

Tint bases are usually distinguished from one another by the amount of white pigment that they contain. The whitest bases are commonly known as Pastel, followed by Midtone, Deeptone, Ultra Deeptone and Neutral or Clear base, which contains no white pigment. Pastel tint bases are useful in the lightest coloured coatings while Neutral bases are used in the darkest coloured coatings, such as navy blue or deep purple.

The tint base is conventionally supplied in containers that are underfilled to levels which are specific for each tint base to allow for a calculated volume of colorant, e.g. pigments and/or dyes, or colorants to be added. Colorants are then added according to a prescribed formulation to fill the containers.

Tint bases are conventionally prepared by combining the vehicle with the pigment in a prescribed proportion depending on the tint base to be obtained.

The pigment in a tint base often comprises an organic pigment or an inorganic pigment or a mixture of organic and inorganic pigments. The pigment might also comprise a dispersing agent and I or other additives.

In the white tint bases, such as Pastel, Midtone, Deeptone and Ultra Deeptone, the white pigment most commonly used is titanium dioxide, which is known as TiO₂, titanium white, pigment white 6 or CI 77891. Titanium dioxide is most commonly used because of its brightness and very high refractive index. It is also an effective opacifier in paint and is used to provide opacity or hiding. Titanium dioxide, however, is more expensive than other conventional white pigments. This expensive pigment has a significant effect on the production price and indeed on the market price of paints and coatings.

With the price of titanium dioxide in mind, manufacturers have provided tint bases that have had some of the titanium dioxide replaced with other white pigments such as Antmony White, Barium sulfate, Lithopone, Cremnitz White and Zinc White.

Due to the differing brightnesses and refractive indexes of these other white pigments, the formulation describing the amount of colorant to be added must be changed in order to obtain the same coloured paints and coatings as would be obtained when titanium dioxide is the white pigment in the tint base. This requires that programmed point-of-sale tinting systems are reprogrammed with new recipes for each tint base that has had at least a part of its titanium dioxide component substituted with a different white pigment.

### SUMMARY OF THE INVENTION

It is an aim of the invention to overcome at least some of the above-mentioned disadvantages when using alternatives to Titanium dioxide and to provide a tint base which is capable of displaying a preselected colour upon addition of a colorant.

The present invention is based on the concept of replacing a portion of the titanium dioxide with an opacity pigment formed by titanium dioxide particles at least partially enclosed within a shell or coating of particles of precipitated calcium carbonate.

Such precipitate calcium carbonate particles typically have a mean particle size in the nanometer range which adhere strongly to titanium dioxide particles.

According to a first aspect of the present invention, there is provided a tint base comprising titanium dioxide, a vehicle, and conventional additives. The tint base is capable of displaying a preselected colour upon the addition of a colorant. At least 4%, preferably about 10 to 25%, by weight of the titanium dioxide is present in the form of opaque aggregates of titanium dioxide particles and precipitated calcium carbonate particles. The titanium dioxide particles are at least partially encased by the particles of precipitated calcium carbonate.

According to a second aspect of the present invention, there is provided a method for preparing a tint base. The method comprises mixing together titanium dioxide, a vehicle, and conventional additives. At least 4%, preferably about 10 to 25%, by weight of the titanium dioxide is added in the form of opaque aggregates of titanium dioxide and precipitated calcium carbonate particles, said titanium dioxide particles being at least partially encased by the particles of precipitated calcium carbonate.

According to a third aspect of the present invention, there is provided a use of opaque aggregates of titanium dioxide and precipitated calcium carbonate particles, wherein the titanium dioxide particles are at least partially encased in the precipitated calcium carbonated particles, as hiding pigments in a tint base.

The invention is defined by the features of the independent claims. Some specific embodiments are defined in the dependent claims.

It has surprisingly been found that a tint base in comprising titanium dioxide in which at least a part of the conventional titanium dioxide particles is replaced with titanium dioxide particles at least partly encased in calcium carbonate particles has essentially similar optical properties, including opacity colour strength and colour matching, as a conventional tint base.

Further features and advantages of embodiments of the present invention will appear from the detailed description as will follow.

Definitions

In the present context, the term “tint base” is a white paint which is formulated to have colours (colorants) added to it at a later date, e.g. in the shop, paint factory or a hardware store for instance, which sells paints. A tint base can also be used as an intermediate composition in industry for producing industrial paints by addition of colorants. Typically, the tint base contains at least part of, typically all or essentially all, the raw materials that are present in standard paints.

“Standard paint” stands for a paint which is formulated for a predetermined use or a range of uses as a coating, which dictate the selection of its pigments, colorants, vehicles and optional additives.

PVC=Particle Volume Concentration

CR=Contrast Ratio (a measure of hiding power)

R/B=Reflectance over a black

L*=Brightness scale 0 to 100. 0 is black, 100 is pure white)

a*=Red/Green shift a −ve value indicates a green colour, a +ve value indicates a red colour

b*=Blue/Yellow shift a −ve value indicates a Blue colour, a +ve value indicates a Yellow colour

T/S=Tint strength or tint reducing power. This is a measure of the ability of the pigments to reduce (make paler) the strength of the colour.

WO=Wet opacity, the hiding power of the paint when first applied and still wet.

Stain=An indication of the porosity of the film.

ΔE is a measure of colour change calculated to be the square root of the sum of change in brightness squared, change in red/green shift squared, and change in blue/yellow shift squared and is expressed more eloquently in the equation

ΔE=\sqrt{(ΔL)²+(Δa)²+(Δb)²}

### EMBODIMENTS

As mentioned above, tint bases conventionally contain titanium dioxide as a white pigment and opacifier titanium dioxide (hiding pigment). Although titanium is the ninth most abundant element in the earth's crust and seventh most abundant metal, extraction of titanium dioxide from its ores is both time consuming and economically expensive. Substituting titanium dioxide with other white pigments causes problems in e.g paint recipes. A new paint recipe must be provided to point of sale (POS) tinting systems for each tint base in which at least a part of the titanium dioxide has been replaced with an alternative white pigment.

Tint bases according to embodiments of the present technology can be coloured or tinted using the same recipe in POS tinting systems to obtain coatings with the same optical properties as would be obtained when tinting or colouring conventional tint bases in which none of the titanium dioxide has been substituted for a different white pigment.

As mentioned above, in one embodiment, at least 4% by weight of the titanium dioxide present in the tint base is present in the form of opaque aggregates of titanium dioxide and precipitated calcium carbonate particles, wherein the titanium dioxide particles are at least partially encased by the particles of precipitated calcium carbonate.

In a further embodiment 5 to 50 weight %, preferably 10 to 48 weight %, particularly 10 to 45 weight %, suitably 10 to 40 weight %, most suitably 10 to 25 weight of the titanium dioxide present in the tint base is present in the form of opaque aggregates of titanium dioxide and precipitated calcium carbonate particles, wherein the titanium dioxide particles are at least partially encased by the particles of precipitated calcium carbonate.

Thus, embodiments of the present invention provide a tint base comprising titanium dioxide, a vehicle, and conventional additives. The tint base is capable of displaying a preselected colour upon the addition of a colorant. At least 4%, preferably at least 5%, for example at least 10%, by weight of the titanium dioxide is present in the form of opaque aggregates of titanium dioxide and precipitated calcium carbonate particles. The titanium dioxide particles are at least partially encased by the particles of precipitated calcium carbonate.

The titanium dioxide particles in their crystalline form can be rutile or anatase or brookite. They are, for example, sourced from ilmenite ore.

Suitable titanium dioxide and precipitated calcium carbonate based opacity pigments can be provided as described in U.S. Pat. No. 9,327,992, the contents of which are herewith incorporated by reference. A suitable opacity pigment product is supplied by FP Pigments Oy, Espoo, under the designation FP-400.

A calcium carbonate-titanium dioxide pigment product used in the present invention comprises titanium dioxide particles encased by calcium carbonate particles. The calcium carbonate particles are manufactured from calcium hydroxide by a process of carbonation (i.e. precipitated calcium carbonate, PCC). During carbonation, the calcium carbonate particles attach to each other in such a way that they form a shell which at least partly encases the titanium dioxide pigment particle(s). On the basis of analyses, the thickness of the shell is on average at least approximately 30 nm, especially at least approximately 50 nm, most suitably approximately 60-500 nm.

Typically, the calcium carbonate particles of the aggregates are mainly non-spherical in form. In particular, their external form is at least mainly rhombic or rhombohedric. The particles are crystalline and their crystal form is mainly calcite or—to a lesser degree—aragonite.

The calcium carbonate particles form a polynuclear calcium carbonate structure, to which pigment particles are strongly attached. A majority of the calcium carbonate particles (i.e. more than 50%, typically even more than 90 or 95%) remain attached to the calcium carbonate crystals both in the dry pigment composition and in the aqueous slurry of the pigment composition.

A considerable percentage (at least approximately 50 weight-%, especially approximately 75 weight-%, most suitably at least approximately 90 weight-%) of the pigment particles which are part of the aggregate remain attached to the calcium carbonate particles even though the calcium carbonate-pigment aggregates are dispersed in water and then dried or—vice versa—even though they are dried to powder form and then dispersed in water.

The calcium carbonate-pigment aggregates have an opacity that is of the same magnitude (with a variation range of approximately 10%) as the associated pigment.

The calcium carbonate structure is formed of calcium carbonate particles, the original size of which, before they are carbonated in order to attach them to other particles, is on average approximately 20 to 250 nm, typically 20 to 200 nm. When the calcium carbonate particles coalesce, they form an essentially continuous surface.

The weight ratio between the pigment particles and the calcium carbonate particles is approximately 90:10 . . . 5:95, preferably approximately 60:40 . . . 5:95, and especially approximately 40:60 . . . 10:90.

An embodiment for producing opacity pigments is discussed in U.S. Pat. No. 9,327,992.

Thus, in general, an aqueous slurry, which is generated by the atomizing of calcium hydroxide-bearing aqueous slurry into carbon dioxide gas in conjunction with the carbonation, is recovered and is most suitably brought to further carbonation. The titanium dioxide pigment and calcium hydroxide-bearing aqueous slurry is conducted through a high energy mixing zone, in which zone the aqueous slurry is broken up into drops or even into nebulous drops, and then dripped into a carbon dioxide-bearing gas. If necessary, dispersants, surface modifying agents or stabilising agents or mixtures thereof are added to the pigment composition to be manufactured during or after manufacturing.

Essentially all of the calcium hydroxide-bearing aqueous slurry can be added to the carbonation together with the pigment particles. However, it is also possible to introduce the calcium hydroxide-bearing aqueous slurry into the carbonation gradually and in several batches, in which case most suitably at least part of the calcium hydroxide-bearing aqueous slurry is free of pigments when it is fed into the carbonation.

The opacity pigments discussed above are used together with conventional titanium dioxide pigments to provide a tint base having a predetermined opacity and brightness.

To produce paint, a colorant is added. Usually, the concentration of the colorant is only on the order of 0.1 to 10%, for example 0.5 to 5%, by weight of the total amount of solids of the final paint. The high opacity of the mixture of titanium dioxide and the opacity pigment, will enhance the formation of a colour such that the concentration of the colorant can be kept in the indicated range.

The tint base also contains a vehicle and optionally conventional additives.

Several vehicles are suitable for use in the tint base, ranging from water to organic solvents to resins. In an embodiment the vehicle is selected from the group consisting of water, resins, aromatic hydrocarbon solvents, aliphatic hydrocarbon solvents and oxygenated solvents. Suitable aromatic hydrocarbons include e.g. benzene, toluene, ethlbenzene, mixed xylenes (BTEX), and high flash aromatic naphthas, as well as derivatives and mixtures thereof. Aliphatic hydrocarbon solvents can be selected from, e.g. mineral spirits or white spirits, hexanes, heptanes, and VM & P Naphthas, as well as derivatives and mixtures thereof. Oxygenated solvents that are suitable as vehicles in tint bases include e.g. ketones, such as acetone, methyl ethyl ketone, methyl isobutyl ketone and isophorone, esters, glycol ethers, and alcohols.

Conventional additives are legion and may in an embodiment be selected from the group consisting of thickeners, bases, dispersants, coalescing agents, antifoaming agents, biocides, chalk, clay, binders and mixtures thereof.

In one embodiment, the present tint bases can be characterized as being selected from the group of Midtone, Deeptone and Ultra Deeptone tint bases.

According to an embodiment, the tint bases are—in particular after the addition of a colorant—suitable for use in paints, preferably matt paints, particularly flat matt paints, optionally satin or silk paints, optionally eggshell paints, possibly semi-gloss paints.

For any given manufacturer, the least glossy paints are typically flat matt and matt paints followed by satin, silk and eggshell paints. Semi-gloss paints are more glossy again with gloss paints being the most glossy of a given manufacturer. For the purposes of the present invention gloss values shall be defined at reflectivity measured at 60° from the vertical using a glossmeter to measure specular reflection gloss of a painted surface. In an embodiment, for flat matt and matt paints the 60° gloss value is in the range of about 0-10 gloss units (GU). In a further embodiment, for eggshell paints the 60° gloss value is in the range of about 2-15 GU. In a particular embodiment, for satin or silk paints the 60° gloss value is in the range of about 5-25 GU. In a suitable embodiment, for semigloss paints the 60° gloss value is in the range of about 25-75 GU. In one embodiment, for gloss paints, the 60° gloss value is in the range of about 70-95 GU.

For low gloss measurements, i.e. if the gloss measurement is less than 10 GU measured at 60°, the incidence angle of light for measuring gloss should be changed to 85°. In one embodiment, measuring at 85°, flat matt or matt paints have a gloss measurement in the range of about 0-15 GU. In a further embodiment, for Eggshell paints the 85° gloss measurement is in the range of about 5-25 GU. In a particular embodiment, for satin or silk paints the 85° gloss measurement is in the range of about 10-40 GU.

Respectively, for high gloss measurements, i.e. gloss measurements exceeding 70 GU measured at 60°, the incidence angle of light for measuring gloss should be changed to 20°. In an embodiment, measuring at 20°, semi-gloss paints have a gloss measurement in the range of about 5-45 GU. In a further embodiment, for gloss paints the 20° gloss measurement is in the range of about 20-90 GU.

Gloss unit (GU) of a glossmeter is a scaling based on a highly polished reference black glass standard with a defined refractive index having a specular reflectance of 100 GU at the specified angle. This standard is used to establish an upper point calibration of 100 with the lower end point established at 0 on a perfectly matt surface.

According to an embodiment, such paints can be used for providing coatings having the corresponding colours. Thus, the paints containing the present tint bases are suitable for use in matt coatings, optional flat matt coatings, suitably satin or silk coatings, possibly in eggshell coatings, particularly in semi-gloss coatings.

Further embodiments relate to methods of preparing a tint base and to methods of producing paints.

As above, the titanium dioxide particles of the opacity pigment are in a crystalline form selected from rutile, anatase or brookite. They can also, just as the conventional pigment, be sourced from ilmenite ore.

According to an embodiment the method comprises mixing together titanium dioxide, a vehicle, and conventional additives, wherein at least 4%, in particular at least 5% by weight of titanium dioxide is added in the form of opaque aggregates of titanium dioxide and precipitated calcium carbonate particles and wherein the titanium dioxide particles are at least partially encased by the particles of precipitated calcium carbonate.

One particular embodiment comprises the steps of adding to a liquid medium, formed by at least one vehicle, titanium dioxide particles and opaque aggregates of titanium dioxide particles and precipitated calcium carbonate particles at a weight ratio of 1:2 to 2:1, in particular about 1:1.2 to 1.2 to 1; dispersing the added particles in the liquid medium to form a dispersion; and admixing with the dispersion an additional amount of titanium dioxide particles to attain a predetermined level of opacity of the dispersion.

As described above, tint bases according to embodiments comprise not only titanium dioxide and a vehicle but they may further contain conventional additives, such as thickeners, bases, dispersants, coalescing agents, antifoaming agents, biocides, chalk, clay, binders and mixtures thereof. The concentration of such compounds is typically 0.1 to 10% by weight of the solids weight of the tint bases.

Opaque aggregates of titanium dioxide and precipitated calcium carbonate particles can be used in various ways. By means of the invention it has been surprisingly found that such aggregates, wherein the titanium dioxide particles are at least partially encased by the particles of precipitated calcium carbonate can be used as hiding pigments in a tint base in one embodiment.

### EXAMPLES

Titanium dioxide comprising at least 4% by weight of aggregates of titanium dioxide particles and precipitated calcium carbonate particles wherein the titanium dioxide particles are at least partially encased by the particles of precipitated calcium carbonate are mixed with a vehicle and conventional additives to provide an intermediate tint base having a contrast ratio of +/−0.20 units compared to the corresponding conventional or standard tint base. To the intermediate tint base is added blue or black tinter to find the relative tint strength compared to the original base. Titanium dioxide is then added back approximately 1-4 percentage points of titanium dioxide missing from conventional or standard tint base) to the intermediate tint base until the tint strength or brightness is essentially the same as the conventional tint base (+/−0.15 ΔL), providing a new tint base. On adding back titanium dioxide, the additives are adjusted to maintain the particle volume concentration (pvc).

New tint bases provided in this way can be exchanged for the corresponding conventional base without the need to adjust the colour recipe database in the POS software. A speed match library can be made to confirm the accuracy of the colours produced by the conventional base and the new base.

The colour recipes produced by the speed match will, in most cases, be the same as the original colour recipes. In one embodiment, this is confirmed with visual checks of selected colours. If necessary, where minor differences are calculated, the new recipe library can be easily uploaded to the POS software.

The method thus provides a reduction of titanium dioxide in a paint. Following a ladder protocol to find the optimum titanium dioxide level, the titanium dioxide level of the reformulated bases is adjusted by adding additional amounts of titanium dioxide until the tint strength of the corresponding original tint base is matched.

The results of tests on a colour matching protocol are shown in Table 1. Table 2 show modification of the new tint base to match tint strength

TABLE 1

| | | Standard | 15% Replacement | 20% Replacement |
|---|---|---|---|---|
| | | % | % | % |
| Water | Water | 28.42 | 28.18 | 28.12 |
| Cellulosic Thickener | Cellosize QP4400H | 0.45 | 0.45 | 0.45 |
| Base (pH control) | Ammonia (28%) | 0.17 | 0.17 | 0.17 |
| Dispersant | Dispex A40 | 0.21 | 0.21 | 0.21 |
| Coalescening Agent | Texanol | 0.81 | 0.80 | 0.80 |
| Antifoam | Foamaster-NXZ | 0.15 | 0.15 | 0.15 |
| Biocide | Acticide BX-H | 0.06 | 0.06 | 0.06 |
| Chalk | Queensfil 25 | 14.25 | 14.13 | 14.10 |
| Calcined Clay | Polestar 200P | 14.25 | 14.13 | 14.10 |
| Opacifying Pigment | FP-Pigment | 0.00 | 2.17 | 2.87 |
| Titanium Dioxide | TIOXIDE ® TR92 | 14.54 | 12.28 | 11.51 |
| Water | Water | 12.25 | 12.73 | 12.88 |
| Antifoam | Foamaster NXZ | 0.00 | 0.00 | 0.00 |
| VAVeoVa Binder | Mowilith LDM 2383 | 14.45 | 14.55 | 14.58 |
| | Total | 100.00 | 100.00 | 100.00 |
| | Vol. Solids | 31.90 | 31.90 | 31.90 |
| | TiO2vc | 17.00 | 14.70 | 14.00 |
| | Evc | 51.00 | 53.30 | 54.00 |
| | pvc | 68.00 | 68.00 | 68.00 |
| | Contrast Ratio | Std | −0.12 | −0.15 |
| | Tint Strength - Blue L* | Std | −0.30 | −0.47 |
| | Tint Strength - Blue ΔE | Std | 0.47 | 0.68 |

Table 1 shows a standard ladder protocol followed to identify optimum titanium dioxide replacement level with opaque aggregates of titanium dioxide particles at least partially encased in particles of precipitated calcium carbonate (FP-Pigment). As can be seen from the table, the conventional base comprises 1454 weight % of titanium dioxide. Reducing the weight percentage of titanium dioxide to 12.28 weight % adding 2.17% of the FP-pigment results in a change of contrast ratio ΔCR of −0.12 (15% replacement). Reducing the weight percentage of titanium dioxide to 11.51 and adding 2.87 weight % of FP-pigment results in a change of contrast ratio ΔCR of −0.15 (20% replacement. The tint strength or brightness—Blue L* is −0.30 and −0.47, respectively. ΔE is 0.47 and 0.68, well within industrial quality control test specification.

TABLE 2

| | | Standard | 15% Replacement | 15% FP-460/13% TiO2 | 20% Replacement | 20% FP-460/17% TiO2 |
|---|---|---|---|---|---|---|
| | | % | % | % | % | % |
| Water | Water | 28.42 | 28.18 | 28.57 | 28.12 | 28.61 |
| Cellulosic Thickener | Cellosize QP4400H | 0.45 | 0.45 | 0.45 | 0.45 | 0.45 |
| Base (pH control) | Ammonia (28%) | 0.17 | 0.17 | 0.10 | 0.17 | 0.10 |
| Dispersant | Dispex A40 | 0.21 | 0.21 | 0.21 | 0.21 | 0.21 |
| Coalescening Agent | Texanol | 0.81 | 0.80 | 0.82 | 0.80 | 0.82 |
| Antifoam | Foamaster NXZ | 0.15 | 0.15 | 0.15 | 0.15 | 0.15 |
| Biocide | Acticide BX-H | 0.06 | 0.06 | 0.06 | 0.06 | 0.06 |
| Chalk | Queensfil 25 | 14.25 | 14.13 | 13.95 | 14.10 | 13.83 |
| Calcined Clay | Polestar 200P | 14.25 | 14.13 | 13.95 | 14.10 | 13.83 |
| Opacifying Pigment | FP-Pigment | | 2.17 | 2.19 | 2.87 | 2.93 |
| Titaniuin Dioxide | TiOXIDE ® TR92 | 14.54 | 12.28 | 12.71 | 11.51 | 12.15 |
| Water | Water | 12.25 | 12.73 | 12.31 | 12.88 | 12.32 |
| Antifoam | Foamaster NXZ | 0.00 | 0.00 | 0.00 | 0.00 | 0.00 |
| VAVeoVa Binder | Mowilith LDM 2383 | 14.45 | 14.55 | 14.52 | 14.58 | 14.54 |
| | Total | 100.00 | 100.00 | 100.00 | 100.00 | 100.00 |
| | Vol. Solids | 31.90 | 31.90 | 31.90 | 31.90 | 31.90 |
| | TiO2vc | 17.00 | 14.70 | 15.30 | 14.00 | 14.80 |
| | Evc | 51.00 | 53.30 | 52.70 | 54.00 | 53.20 |
| | pvc | 68.00 | 68.00 | 68.00 | 68.00 | 68.00 |
| | Contrast Ratio | Std | −0.12 | 0.02 | −0.15 | −0.04 |
| | Tint Strength - Blue L* | Std | −0.30 | −0.17 | −0.47 | −0.20 |
| | Tint Strength - Blue ΔE | Std | 0.47 | 0.37 | 0.68 | 0.42 |

Table 2 show the formulations described in Table 1 into which small amounts of titanium dioxide have been added back to compensate for the reduction in tint strength. As can be seen, by adding back small amounts of titanium dioxide the change in contrast ratio and the change in tint strength have been reduced considerably in both tint bases.

The three tint bases, standard, 15% FP pigment/13% titanium dioxide, and 20% FP pigment/17% titanium dioxide were then calibrated in a matching Chromaflo database. This was done by making drawdowns of various quantities of black colorant in each base and measuring these values in the database. In this way the coloristic link between the three bases and the standard Chromaflow base were established.

After a perfect calibration, file matches (speed matches) of the NCS Fandeck were created in all 3 bases. The colorant system used was Monicolour C.

Colour formulations which have a maximum addition of 5% of colorants in a 1 litre formulation were focussed on.

This resulted in 3 sets of colour formulations (1 set for each base). In most cases the formulations of the 15/13 and 20/17 base were the same as the formulation of the STD base. Any differences found were very small and within the normal tolerances of a tinting system.

52 colours were selected coveting the whole colour area. These colours were made in the 3 bases in real paint using the speed file matches. This was to enable a visual check of the accuracy of the colours of the 15/13 and 20/17 base compared to the standard base. The result is that all 52 colours are visually perfect matches in both bases compared to the standard.

Out of the 52 colours the 14 most difficult colours to match were selected. Difficult in this case means those colours where the human eye immediately sees the difference if the colour is not the same. The 52 colours are shown in Table 3. The 14 most difficult to colour match of those colours are shown in Table 4.

TABLE 3
Colour Matched Colours

| | | | | |
|---|---|---|---|---|
| NCS S 0510-B | NCS S 0510-R | NCS S 0510-Y | NCS S 0510-G | NCS S 0520- |
| | | | | G50Y |
| NCS S 1030- | NCS S 1030- | NCS S 3010- | NCS S 3010- | NCS S 3010- |
| R10B | Y30R | B30G | G30Y | R30B |
| NCS S 3010- | NCS S 1000-N | NCS S 2000-N | NCS S 3000-N | |
| Y30R | | | | |
| NCS S 0520- | NCS S 0520- | NCS S 0520- | NCS S 0530- | NCS S 0530- |
| B50G | R70B | Y50R | B50G | G40Y |
| NCS S 0530- | NCS S 0530- | NCS S 0540- | NCS S 0540- | NCS S 0540- |
| R80B | Y40R | B30G | G20Y | R20B |
| NCS S 0540- | NCS S 1010- | NCS S 1010- | NCS S 1010- | NCS S 1010- |
| Y30R | B90G | G40Y | R90B | Y70R |
| NCS S 1020- | NCS S 1020- | NCS S 1020- | NCS S 1020- | NCS S 1030- |
| B30G | G50Y | R40B | Y30R | B10G |
| NCS S 1030- | NCS S 1030- | NCS S 1040-R | NCS S 1040- | NCS S 1040-G |
| B10G | G10Y | | B10G | |
| NCS S 1040- | NCS S 2010- | NCS S 2010- | NCS S 2010- | NCS S 2010- |
| Y40R | B70G | G70Y | R70B | Y70R |
| NCS S 2020- | NCS S 2020- | NCS S 2020- | NCS S 2020- | NCS S 3020-B |
| B50G | G50Y | R50B | Y50R | |
| NCS S 3020-G | NCS S 3020-R | NCS S 3020-Y | | |

TABLE 4
Difficult to Colour Match Colours

| | | | | |
|---|---|---|---|---|
| NCS S 0510-B | NCS S 0510-R | NCS S 0510-Y | NCS S 0510-G | NCS S 0520- |
| | | | | G50Y |
| NCS S 1030- | NCS S 1030- | NCS S 3010- | NCS S 3010- | NCS S 3010- |
| R10B | Y30R | B30G | G30Y | R30B |
| NCS S 3010- | NCS S 1000-N | NCS S 2000-N | NCS S 3000-N | |
| Y30R | | | | |

Those 14 colours were made again in the 15/13 and 20/17 base in real paint. However this time using only the file match of the STD base. Meaning no possible adjustments in the file match compared to the standard. This is the case when a customer is changing the base using FP-pigment but is not making any changes in the colour formulations in the POS software.

This resulted also in 14 visually perfect matches in both bases compared to the standard.

Thus, by adjusting the colour strength of the bases that use FP-pigment to the colour strength of the original base not using FP-pigment, there is no need to change the colour formulations in the POS system.

It is to be understood that the embodiments of the invention disclosed are not limited to the particular structures, process steps, or materials disclosed herein, but are extended to equivalents thereof as would be recognized by those ordinarily skilled in the relevant arts. It should also be understood that terminology employed herein is used for the purpose of describing particular embodiments only and is not intended to be limiting.

Reference throughout this specification to one embodiment or an embodiment means that a particular feature, structure, or characteristic described in connection with the embodiment is included in at least one embodiment of the present invention. Thus, appearances of the phrases “in one embodiment” or “in an embodiment” in various places throughout this specification are not necessarily all referring to the same embodiment. Where reference is made to a numerical value using a term such as, for example, about or substantially, the exact numerical value is also disclosed.

As used herein, a plurality of items, structural elements, compositional elements, and/or materials may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary. In addition, various embodiments and example of the present invention may be referred to herein along with alternatives for the various components thereof. It is understood that such embodiments, examples, and alternatives are not to be construed as de facto equivalents of one another, but are to be considered as separate and autonomous representations of the present invention.

Furthermore, the described features, structures, or characteristics may be combined in any suitable manner in one or more embodiments. In the following description, numerous specific details are provided, such as examples of lengths, widths, shapes, etc., to provide a thorough understanding of embodiments of the invention. One skilled in the relevant art will recognize, however, that the invention can be practiced without one or more of the specific details, or with other methods, components, materials, etc. In other instances, well-known structures, materials, or operations are not shown or described in detail to avoid obscuring aspects of the invention.

While the forgoing examples are illustrative of the principles of the present invention in one or more particular applications, it will be apparent to those of ordinary skill in the art that numerous modifications in form, usage and details of implementation can be made without the exercise of inventive faculty, and without departing from the principles and concepts of the invention. Accordingly, it is not intended that the invention be limited, except as by the claims set forth below.

The verbs “to comprise” and “to include” are used in this document as open limitations that neither exclude nor require the existence of also un-recited features. The features recited in depending claims are mutually freely combinable unless otherwise explicitly stated. Furthermore, it is to be understood that the use of “a” or “an”, that is, a singular form, throughout this document does not exclude a plurality.

### INDUSTRIAL APPLICABILITY

At least some embodiments of the present invention find industrial application in production of tint bases and paint compositions, as well as in the production of coatings and in the preparation of coatings using such compositions. As will appear from the above, the present tint bases can be provided both as consumer products to be formulated at a hardware store or paint shop as well as an intermediate composition to be used at a paint factory for formulating the final paint composition. In both cases, and in particular in the case of consumer products, the tint base is for example supplied in a closed container, typically a metal or plastic container. In particular tint bases of the present kind are supplied in metal containers, which preferably have a lid which hermetically closes the container. The volume of the container can vary broadly, from about 0.1 to 250 l, in particular about 0.3 to 100 I, such as 0.3 to 10 l. As mentioned above, the container is typically underfilled with 5 to 20%, for example about 10%, with the tint based.

1. A tint base comprising:
titanium dioxide, and
a vehicle,
wherein the tint base is capable of displaying a preselected colour upon the addition of a colorant,
wherein at least 4% by weight of the titanium dioxide is present in the form of opaque aggregates of titanium dioxide particles and precipitated calcium carbonate particles, and wherein the titanium dioxide particles are at least partially encased by the particles of precipitated calcium carbonate.

2. The tint base according to claim 1, wherein the vehicle is selected from the group consisting of aromatic hydrocarbon solvents, aliphatic hydrocarbon solvents, oxygenated solvents, water, resins and mixtures thereof.

3. The tint base according to claim 1, wherein 5 to 50 weight % of the titanium dioxide present in the tint base is present in the form of opaque aggregates of titanium dioxide and precipitated calcium carbonate particles, wherein the titanium dioxide particles are at least partially encased by the particles of precipitated calcium carbonate.

4. The tint base according to claim 1 contained in a closed container.

5. The tint base according to claim 1, wherein the tint bases are incorporated matt paints, flat matt paints, satin or silk paints, eggshell paints, or semi-gloss paints.

6. The tint base claim 1, wherein the tint bases are capable of providing coatings having a gloss value measured at 60° from the vertical using a glossmeter of about 0-10 gloss units and/or a gloss value measured at 85° from the vertical using a glossmeter of about 0-15 gloss units.

7. The tint base according claim 1, wherein the tint bases are capable of providing coatings having a gloss value measured at 60° from the vertical using a glossmeter of about 2-15 gloss units and/or a gloss value measured at 85° from the vertical using a glossmeter of about 5-25 gloss units.

8. The tint base according to claim 1, wherein the tint bases are capable of providing coatings having a gloss value measured at 60° from the vertical using a glossmeter of about 5-25 gloss units and/or a gloss value measured at 85° from the vertical using a glossmeter of about 10-40 gloss units.

9. The tint base according to claim 1, wherein the tint bases are capable of providing coatings having a gloss value measured at 60° from the vertical using a glossmeter of about 25-75 gloss units and/or a gloss value measured at 20° from the vertical using a glossmeter of about 5-45 gloss units.

10. The tint base according to claim 1, wherein the tint bases are capable of providing coatings having a gloss value measured at 60° from the vertical using a glossmeter of about 70-95 gloss units and/or a gloss value measured at 20° from the vertical using a glossmeter of about 20-90 gloss units.

11. A paint composition comprising the tint base of claim 1 and at least one colorant.

12. A method of preparing a tint base, comprising mixing together titanium dioxide and a vehicle, wherein at least 4% by weight of titanium dioxide is added in the form of opaque aggregates of titanium dioxide particles and precipitated calcium carbonate particles and wherein the titanium dioxide particles are at least partially encased by the particles of precipitated calcium carbonate.

13. The method according to claim 12, wherein the vehicle is selected from the group consisting of aromatic hydrocarbon solvents, aliphatic hydrocarbon solvents, oxygenated solvents, water, resins and mixtures thereof.

14. The method according to claim 12, wherein 10 to 25 weight % of the titanium dioxide present in the tint base is present in the form of opaque aggregates of titanium dioxide particles and precipitated calcium carbonate particles.

15. The method according to claim 12, wherein the mixing comprises:
adding to a liquid medium, formed by at least one vehicle, titanium dioxide particles and opaque aggregates of titanium dioxide particles and precipitated calcium carbonate particles at a weight ratio of 1:2 to 2:1,
dispersing the added particles in the liquid medium to form a dispersion, and
admixing with the dispersion an additional amount of titanium dioxide particles to attain a predetermined level of opacity of the dispersion.

16. (canceled)

17. (canceled)

18. The tint base of claim 1, wherein 10 to 25 weight % of the titanium dioxide is present in the form of opaque aggregates of titanium dioxide particles and precipitated calcium carbonate particles.

19. The tint base of claim 1, wherein the precipitated calcium carbonate particles have an average size of 60-500 nm.

20. The tint base of claim 1, wherein the vehicle is selected from the group consisting of aromatic hydrocarbon solvents, aliphatic hydrocarbon solvents, oxygenated solvents, water, resins, and mixtures thereof.

21. The tint base of claim 1, further comprising an additive selected from the group consisting of a thickener, base, dispersant, coalescing agent, antifoaming agent, biocide, chalk, clay, binder, and a mixture thereof.

22. The tint base of claim 1, w herein a concentration of colorant in the paint is 0.1 to 10% by weight of a total amount of solids in the paint.
